(19) United States
(12) Patent Application Publication
(10) Pub. No.: US 2011/0313935 A1
(43) Pub. Date: Dec. 22, 2011

(54) ENVIRONMENTAL MANAGEMENT PLANS

(76) Inventor: Terry John Muir, Merewether (AU)

(21) Appl. No.: 13/164,621

(22) Filed: Jun. 20, 2011

Related U.S. Application Data
(63) Continuation-in-part of application No. 11/522,619, filed on Sep. 18, 2006, now abandoned.

(51) Int. Cl. G06Q 10/00

(52) U.S. Cl. 705/301

(57) ABSTRACT

A method of, and apparatus for generating an environmental management plan for management of golf courses is described. A game is also described which, when played, generates the environmental management plan. In the method, apparatus and game, a set of tasks and sub-tasks are associated with holes and strokes respectively in a game of golf so that a user or player may easily step through the generation of an environmental management plan which complies with a selected environmental management standard and world's best practice for managing golf course environments. Content for completing the plan is provided, documents are generated, and assistance is given in customising and completing each document. The game and method is typically conducted by a processing system. A progress indicator is also provided which is in the form of an animated golfer who executes the strokes associated with the sub-tasks, which facilitates improved motivation to complete the management plan.

### CROSS-REFERENCES TO RELATED APPLICATIONS

This application is a continuation-in-part of U.S. patent application Ser. No. 11/522,619, filed Sep. 8, 2006, the complete disclosure of which is incorporated herein by reference.

### FIELD OF THE INVENTION

The present invention relates generally to a method and apparatus for preparing environmental management plans, and in particular to a method and apparatus for preparing environmental management plans for the environmental management of golf courses.

### BACKGROUND OF THE INVENTION

The reference to any prior art in this specification is not, and should not be taken as, an acknowledgment or any form of suggestion that the prior art forms part of the common general knowledge.

It is known to prepare environmental plans which comply with published standards. However, preparing these plans, and motivating staff to prepare the plans, is extremely difficult and time consuming, at least partly because of the length of the plan required, means the plan takes many months to complete, the complexity of the language used, the different skill sets required to complete the plan, and the mental focus and discipline required of staff to complete the plan.

Furthermore, because of the known complexity of environmental plans, those charged with preparing the plan, a golf course superintendent, can have difficulty comprehending and motivating themselves to prepare the plans.

The present invention seeks to ameliorate one or more of the abovementioned disadvantages.

### BRIEF SUMMARY OF THE INVENTION

In accordance with the invention there is provided a method of establishing an environmental plan for a golf course by displaying a group of tasks required to be undertaken to complete the environmental plan in a format that illustrates the entire set of tasks and sequentially presents each task as being formed of subtasks which are displayed in a dynamic pictorial representation, with each sub-task representing a stroke on a hole of the golf course and a completed sub-task being demonstrated with an animated player completing the stroke and moving to the next stroke of the hole until sinking the putt to demonstrate completion of the task.

In another broad form the present invention provides a method of preparing an environmental management plan for implementation in the environmental management of a golf course, the environmental management plan comprising a selected plurality of critical tasks and sub-tasks to comply with a selected environmental management standard, the method using a processing system and comprising the steps of, in the processing system:

a) displaying on a display, simultaneously or in a selected sequence, a plurality of holes and/or associated strokes for playing a game of golf;

b) associating each critical task with a selected hole in the golf game;

c) associating a selected number of sub-tasks which are required to complete a respective critical task, with a stroke of a respective hole;

d) causing information and instructions associated with each sub-task to be displayed on at least the display when the stroke is selected to be played.

It may be that the player may select a hole and/or stroke to play from a menu or other selection tool. However, typically, the method comprises, in the processing system, the step of causing the display of a selected playing area on the display so that a hole may be selected by a user from a plurality of holes. Typically the playing area is a representation of a golf course or a golf hole.

Typically the method comprises, in the processing system, the step of displaying 18 tasks in a selected sequence corresponding with 18 holes in the representation of the golf course.

Typically the method comprises, in the processing system, the step of providing between 3 and 5 sub-tasks for each task, so that each hole is between par 3 and par 5.

Typically the method comprises, in the processing system, the step of providing linked documents or links to documents and/or templates and/or worked examples and/or case studies stored on a storage device connected to the processing system.

Typically the method comprises, in the processing system, the step of keeping and/or displaying a first tally or score relating to the number of completed tasks or sub-tasks in the selected environmental compliance plan, by completing a scorecard associated with the golf game.

Typically the method comprises, in the processing system, the step of keeping and updating a second tally of uncompleted tasks or sub-tasks in a memory or storage device connected to the processing system.

Typically the method comprises, in the processing system, the step of evaluating a ratio of uncompleted tasks or sub-tasks to competed tasks or sub-tasks to assess compliance of the environmental management plan with the selected environmental management standard.

Typically the method comprises, in the processing system, the step of generating forms and documents in response to player answers to instructions posed in a previous step.

Typically the method comprises, in the processing system, the step of displaying a progress indicator on the display device, the progress indicator being an animation of a golf player playing the stroke associated with the relevant sub-task being undertaken on one of the holes. This augments the player's own knowledge of their progress through the preparation of the environmental management policy and plan, by giving a visual indication in a dedicated portion of the display device. That is, all golfers would know exactly how many holes they have to play after they have just completed, say, the 8^{th} hole. The indicator simply adds to that knowledge, so the player knows how many tasks must be completed before they complete the preparation of the environmental management policy.

In yet another broad form the present invention provides apparatus for preparing an environmental management plan for implementation in the environmental management of a golf course, the apparatus comprising a processing system and a display device for:

(i) displaying a plurality of holes and associated strokes either simultaneously or in a selected sequence, for playing a game of golf;

(ii) associating each critical task with a selected hole in the golf game;

(iii) associating a selected number of sub-tasks which are required to complete a respective critical task, with a stroke of a respective hole;

(iv) causing content and instructions associated with each sub-task to be displayed on at least the display device when the stroke is selected to be played.

In a third broad form the present invention provides a game for preparing an environmental management policy or plan to manage a golf course which complies with a selected environmental management standard, the game comprising: a playing area in the form of a metaphorical golf course; a plurality of rules which govern progression through the metaphorical golf course by completing each hole, the plurality of rules requiring progression through the metaphorical golf course be contingent upon completion of a number of tasks and sub-tasks in the environmental management policy, each task associated with a respective hole on the metaphorical golf course.

Typically the game is conducted by a processing system connected to one or more input/output devices in the form of a keyboard, mouse and screen. Typically the processing system is connected to a memory and a storage area, and a printer.

Typically, during a hole of the game, game players are presented with content on the display. The content comprises in some embodiments, a series of questions, or forms and templates relating to, for example, the environment around the actual golf course for which the environmental management policy or plan is being generated, or staff levels of training for environmental storage, environmental hazards, and risk management of hazards. Players in some holes, complete the holes and therefore respective tasks in the generation of the plan by undergoing training provided by the content shown on the display, such as legislation governing various environmental aspects of golf course management, or where to store certain documents, and/or where to store certain chemicals. Players will, in some holes, be trained in how to create and manage databases of various items such as Objectives for environmental targets and the like.

The processing system provides templates and leaves various spaces in each field so that the player may complete the templates in a manner which is customised to the golf course which they manage.

Typically the game comprises an electronically linked environmental scorecard so that a player may be aware of how many holes he has satisfactorily completed. Typically the scorecard is stored in the memory and/or storage device, so that the player may partially complete the game in one session and then save their progression at the partially completed stage and return to the game at a later date.

Typically the game comprises an animated progress indicator that is in the form of a golfer who undertakes each stroke and progresses along the hole as each stroke is completed. This has the effect of motivating the player to complete the next stroke and thus strive to complete the management plan. Encouraging audio such as crowds clapping a difficult bunker shot for example may be played at various intervals to maintain the motivation of the player.

Typically the game comprises 18 holes, which represent 18 elements of an environmental management plan which meets world's best practice for environmental management.

In still yet another aspect of the invention there is provided a computer program product for interactively generating an environmental management plan for a golf course, the plan having a series of tasks required for completion of the plan, each task having at least one sub-task, wherein the computer program product configures a computer to:

(a) display the series of tasks, each task being associated with a hole of a metaphorical golf course;

(b) allow a user to select at least one of the holes of the metaphorical golf course;

(c) display a fairway of the selected hole of the metaphorical golf course, the fairway having a select number of shots, each shot being associated with a sub-task that is required to complete the hole;

(d) allowing a user to select at least one of the shots;

(e) displaying a location of the fairway associated with the shot;

(f) provide a link to a document that forms part of the environmental management plan, the document being required to be completed in order to complete the associated shot.

### BRIEF DESCRIPTION OF THE DRAWINGS

An example of the present invention will now be described with reference to the accompanying drawings, in which:

FIG. 1 is a schematic of a system for effecting the game and method;

FIG. 2 is a flowchart of an example of a method of preparing an environmental management plan or policy in a processing system;

FIG. 3 illustrates a plurality of tasks associated with holes of a golf course and a scorecard which displays the number of subtasks or shots associated with each hole and provides an indicator to allow a user to determine if a particular hole has been completed or not;

FIG. 4 illustrates a simplified example of a first display;

FIG. 5 illustrates a simplified example of a second display;

FIG. 6 illustrates a simplified example of a third display;

FIG. 7 illustrates a simplified example of a forth display;

### DETAILED DESCRIPTION OF THE INVENTION

The following description, given by way of example only, is provided in order to provide a more precise understanding of the subject matter of a preferred embodiment or embodiments.

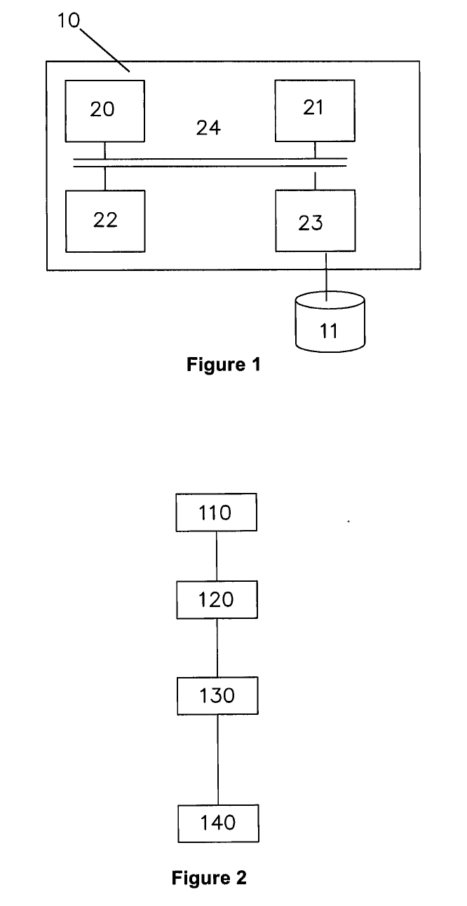

An example of an architecture for preparation of an environmental management plan for environmental management of golf courses is shown in FIG. 1. The architecture is also used for playing a game which assists in the preparation of the environmental management plan for golf courses.

An example of a processing system (10) is shown in FIG. 1. As shown the processing system (10) comprises a processor (20), a memory (21), an input/output device (22), such as a keyboard and display or the like, and an external interface (23), coupled together via a bus (24). In use the external interface (23) may be coupled to the database (11). A printer may be included in the processing system.

Accordingly, the processing system (10) may be any form of processing system, such as a computer server, a network server, a web server, a desktop computer, a lap-top or the like. Alternative specialised hardware may be used.

Referring now to FIG. 2, there is illustrated a flow chart showing an example in broad form, of a method of preparing an environmental management plan or policy in a processing system.

In particular, at step (110) the method comprises displaying simultaneously or in a selected sequence, a plurality of holes and/or associated strokes for playing a game of golf. At step (120) the method comprises associating each critical task with a selected hole in the golf game. At step (130) the method associates a selected number of sub-tasks which are required to complete a respective critical task, with a stroke of a respective hole. Finally, at step (140), a display step is taken wherein information and instructions associated with each sub-task is displayed when the stroke is selected to be played.

That is, the method involves a game of golf which is played on a playing area by a player wherein the holes and strokes of the game correspond with the tasks and sub-tasks to be undertaken in the generation of an environmental management plan. This method breaks down the huge number of seemingly incomprehensible documents and requirements of an international environmental management standard to a plurality of easily accessible tasks and sub-tasks which may be taken at any time and at any pace. The method uses a metaphor of playing a game of golf in order to generate an environmental management plan which complies with a selected international standard (in this case ISO14001).

The method allows a person who is familiar with the game of golf (such as golf course superintendents) to immediately ascertain where in the management plan generation they are, and how many steps there may be to complete the plan. For example, the superintendent (the player) may see that they have completed the 8^{th} hole and they then can see that they have only 10 holes to go before the management plan is complete.

The method includes the step of displaying content which instructs and trains and assists with the completion of specific environmental management planning tasks. The content includes, for example, information regarding Emergency Response and facilitates the completion and preparation of an Emergency Preparedness and Response Matrix, as well as Standard Operating Procedures for Operational Control of washbays, storage of chemicals and fuel, irrigation, waste management, spills, construction and renovation and the like. Environmental Training matrices are presented and instructions are given in their generation. Examples of Environmental Risk Registers are displayed and instructions are given in their preparation. Monitoring of the abovementioned factors is facilitated, and diarising of monitoring of certain events such as training, updates in laws, review of operational controls and emergency training responses is instructed and in some embodiments conducted. The abovementioned content is accessed by electronic links to documents stored in the processing system which may be printed and stored in hard copy registers separate from the processing system, or stored in the processing system itself.

The method may further include the step of displaying a progress indicator in the form of an animated golf player and golf ball which may be seen to execute the stroke which has just been completed. This increases motivation of the user and encourages the progression to the next task.

The method may be effected by a processing system and the game played on a processing system.

Some holes are designated par 3 and others par 4 and others par 5. That is, par 3 holes require three shots or strokes and a par 4 or par 5 requires four and five shots or strokes, respectively. This indicates the degree of difficulty of the hole and shows a person at a glance how much effort is required before entering into the tasks and sub-tasks required to complete the task. The par-indicator also corresponds with the number of sub-tasks associated with that hole. Thus, par 5 holes have 5 sub-tasks to complete before the task is completed.

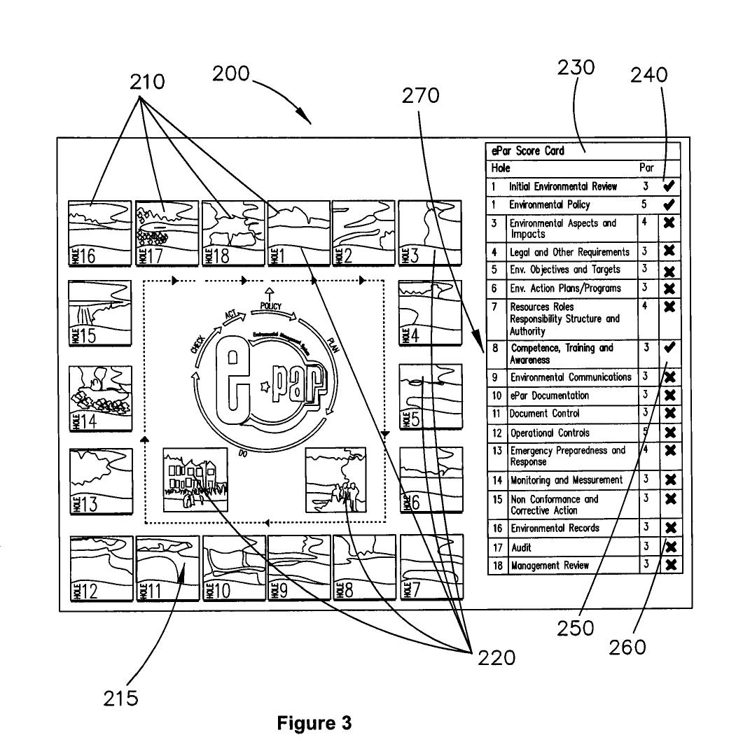

Referring to FIG. 3, there is shown an example of an interactive computerised display (200) for the preparation of an environmental management plan. The display (200) includes a sequence of holes (210) for playing a game of golf. The holes (210) are displayed on a playing area (215) of a metaphorical golf course (220). The playing area (215) has 18 holes and is displayed on a monitor. The holes (210) correspond with the following tasks in the preparation of the environmental plan:

Hole 1. Initial Environmental Review.

Hole 2. Environmental policy.

Hole 3. Environmental Aspects and impacts.

Hole 4. Legal and other requirements.

Hole 5. Environmental Objectives and Targets.

Hole 6. Environmental Action Plans.

Hole 7. Structure and responsibility.

Hole 8. Competence, Training and Awareness.

Hole 9. Communication.

Hole 10. Environmental Management Program Documentation.

Hole 11. Document Control

Hole 12. Operational controls

Hole 13. Emergency response.

Hole 14. Monitoring and measuring.

Hole 15. Non-conformance and corrective and preventive actions.

Hole 16. Records,

Hole 17. Audit.

Hole 18. Management review.

The movement of the input device (mouse) highlights certain holes which may be played in any order in order to generate the management plan. Preferably, the holes are played from 1 to 18, but if a player becomes stuck they may move onto another hole and return to the difficult hole at a later stage.

FIG. 3 also displays an environmental scorecard (230) which, again corresponds with a golf scorecard in the method or game being played. The scorecard (230) may be displayed on the right hand side of the display and provides a list (270) for reckoning of the progress through the preparation of the plan. The list (270) includes reference to each of the holes or tasks and the “par” otherwise known as shots or sub-tasks associated with each hole. Therefore, the user knows upfront how many tasks and subtasks are required to complete the environmental management plan.

For example, the 8^{th} hole is indicated as being associated with the critical task or task of “Competence, Training and Awareness” which is indicated as being a par 3 or requiring 3 strokes or shots and accordingly requires the completing of 3 subtasks to finish the hole.

Each hole in the list (270) is provided with indicators (240) which record the state of the hole as being incomplete or complete. The complete state is indicated with a tick (250) and the incomplete state is indicated with a cross (260).

In this example, the tasks associated with the 1^{st}, 2^{nd} and 8^{th} holes referred to on the list (270) have been completed. Therefore, there is a tick (250) next to the 1^{st}, 2^{nd} and 8^{th} holes referred to on the list (270). This allows a user to easily understand which tasks on the list (270) have been completed and therefore understand the progress made in preparation of the environmental management plan. The state of the indicators, (240) as being a tick (250) or cross (260), may be stored in the memory (21) of the processing system (20). Accordingly, a user may partially complete the environmental management plan and return to the plan at a later date.

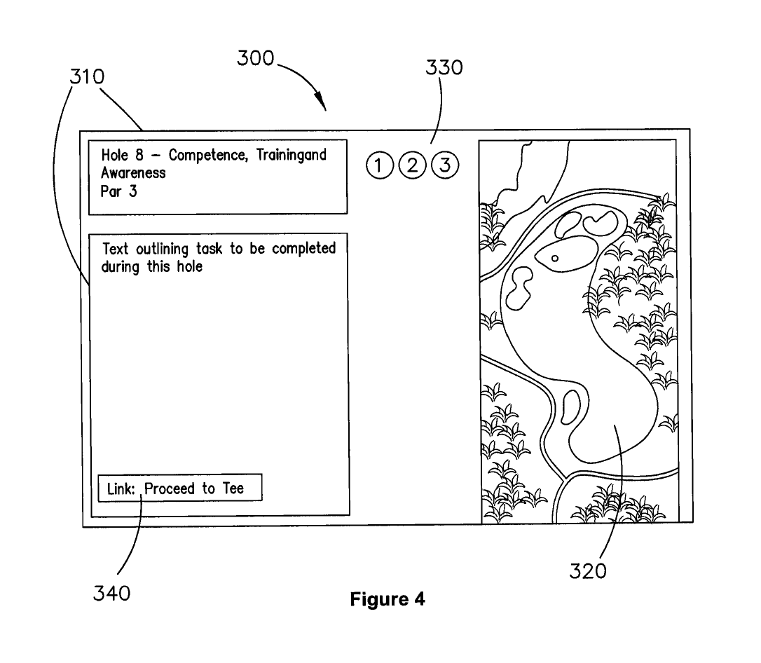

FIGS. 4 to 7 provide a specific example of displays provided as a user progresses through the 8^{th} hole.

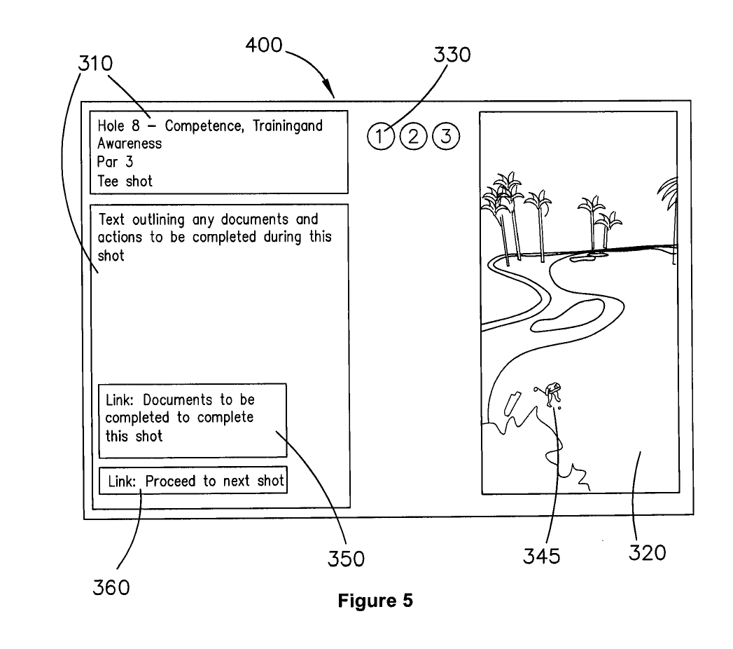

Referring to FIG. 4, there is shown a simplified example of a first display (300) when entering the 8^{th} hole. This screen (300) provides a text box (310) providing a description of the subtasks which need to be completed to complete this hole. The display (300) also provides an illustration of a fairway (320) of the particular hole being played, which in this example is the 8^{th} hole. In this example, the hole is par 3, requiring 3 shots or strokes, through which the user will progress. Accordingly, the middle top of the screen also shows three linearly arranged golf balls (330) with the numbers 1 to 3 which light up or are otherwise indicated to show the user which stroke or shot the user they is currently completing. Once the user has read the introductory information, the user clicks “Proceed to Tee” button (340) which progresses the user to the second display (400) and first shot or stroke as illustrated in FIG. 5.

Referring to FIG. 5, the first of the three golf balls (330) is now lit up and an animated golf player (345) is shown at a tee location of the fairway (320) of the metaphorical golf course (220) as was shown in FIG. 4. The text box (310) outlines which documents or actions are needed to be complete this stroke or subtask. A link (350) or links are provided which displays a document or documents which need to be completed by the user.

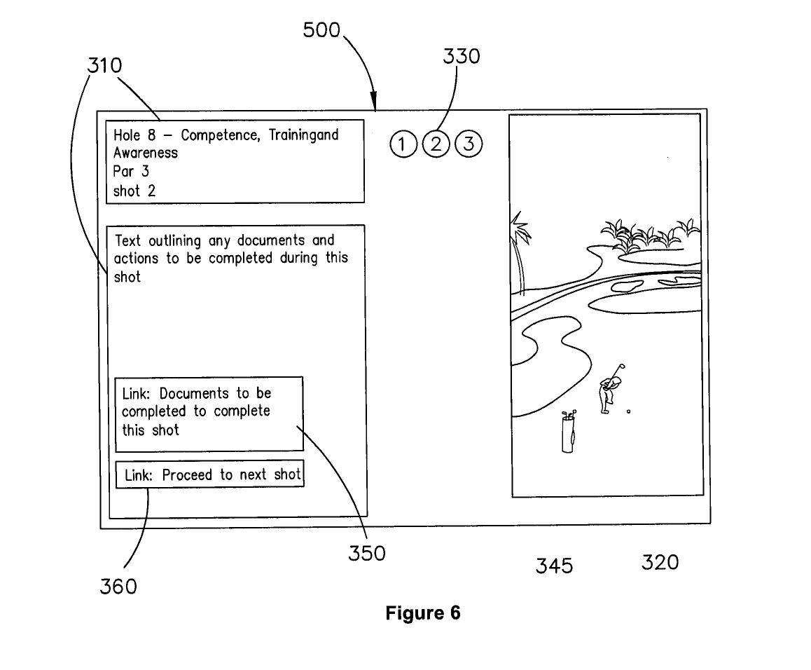

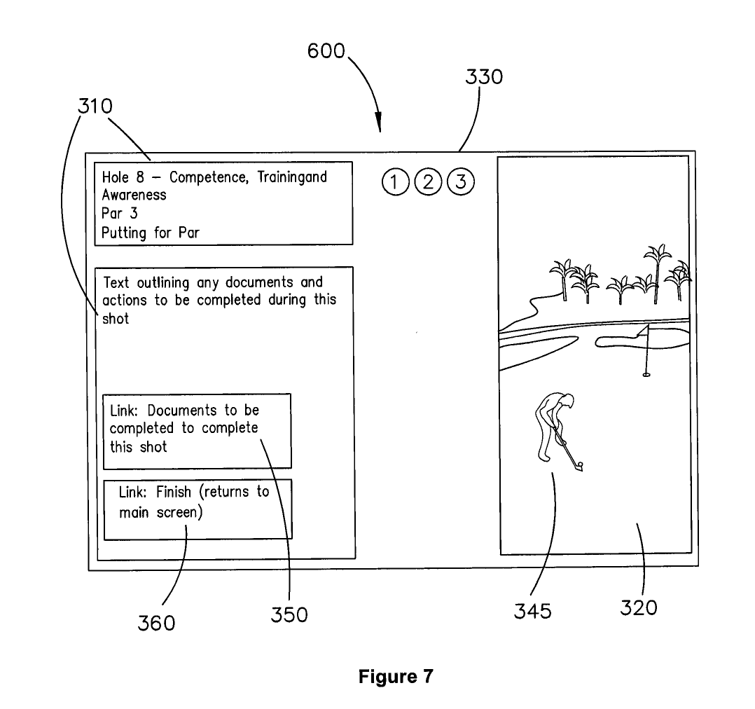

Once the documents are complete the user clicks the link “Proceed to next shot” (360) to advance to the third display (500) and second shot or stroke as shown in FIG. 6 which provides a similar set of instructions and links to relevant documents as is present in the second display (400) or first shot as illustrated in FIG. 5. However, now the first and second of the three golf balls (320) are lit up to indicate to the user that the second shot or stroke is now being played. The display of FIG. 6 also shows the animated golf player (345) mid-way down the fairway (320) of the metaphorical golf course (220) previously shown or partially shown in FIGS. 4 and 5. When the user has completed the second shot or stroke the user clicks the link “Proceed to next shot” (360) and moves the forth display (600) as illustrated in FIG. 7.

Referring to FIG. 7, the final shot is indicated by having all three golf balls (330) lit up to indicate that the user is at the third shot or stroke. Moreover, the text box (310) indicates the user is now putting for par and displays the animated golf player (340) on a putting green ready to complete the hole. The user is then able to access links (350) to documentation which is required to be completed for the final shot or stroke of the hole. Once the final shot or stroke of the hole is complete, the user clicks “Finish” (370) which updates the score card (230) by recording a tick (250) in the box, in this case, next to the 8^{th} hole as is shown in FIG. 3. The user is then returned to the screen as shown in FIG. 3 and is able proceed to another hole.

The other holes and associated subtasks are able to be completed in a similar manner as is above described for the 8^{th} hole with the final result being a completed a completed environmental management plan, inclusive of the required documentation and information to enable a golf course to be considered to meet a particular environmental compliance standard such as ISO14001.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. A method of establishing an environmental plan for a golf course by displaying a group of tasks required to be undertaken to complete the environmental plan in a format that illustrates the entire set of tasks and sequentially presents each task as being formed of subtasks which are displayed in a dynamic pictorial representation, with each sub-task representing a stroke on a hole of the golf course and a completed sub-task being demonstrated with an animated player completing the stroke and moving to the next stroke of the hole until sinking the putt to demonstrate completion of the task.

2. The method of claim 1, wherein the tasks are displayed in a form representative of a layout of a golf course.

3. The method of claim 2, wherein completion of the tasks is recorded in a scorecard which is displayed together with the representation of the golf course so that a user is able to assess the progress of the environmental plan.

4. The method of claim 1, wherein the method includes generation of documentation for the environmental plan in response to progress of the animated player progressing through the holes of the course.

5. A method of preparing an environmental management plan for implementation in the environmental management of a golf course, the environmental management plan comprising a selected plurality of tasks to comply with a selected environmental management standard, the method using a processing system and comprising the steps of, in the processing system:
a) displaying, simultaneously or in a selected sequence, a plurality of holes and/or associated strokes for playing a game of golf;
b) associating each of the tasks, selected from a plurality of tasks associated with the environmental policy to comply with a selected environmental management standard, with a selected hole in the golf game;
c) associating a selected number of the tasks which are required to complete a respective hole, with a stroke of a respective hole;
d) displaying information and instructions associated with each task when the stroke is selected to be played.

6. The method in accordance with claim 5, wherein the tasks include critical tasks associated with a selected hole in the golf game and sub-tasks required to complete the respective critical task.

7. The method in accordance with claim 6 comprising, in the processing system, the step of displaying a selected playing area so that in use a hole or stroke is selected by a user from a plurality of holes or strokes wherein the playing area is a representation of a golf course or a golf hole.

8. The method in accordance with claim 6 comprising, in the processing system, the step of providing 18 tasks corresponding with 18 holes and between 3 and 5 sub-tasks for each task, so that each hole is between par 3 and par 5.

9. The method in accordance with claim 6 comprising, in the processing system, the step of providing linked content or documents or links to content or documents and/or templates and/or worked examples and/or case studies stored on a storage device connected to the processing system.

10. The method in accordance with claim 6 comprising, in the processing system, the step of keeping and/or displaying a first tally or score relating to the number of completed tasks or sub-tasks in the selected environmental compliance plan, by completing a scorecard associated with the golf game.

11. The method in accordance with claim 6 comprising, in the processing system, the step of keeping and updating a second tally of incomplete tasks or sub-tasks in a memory or storage device connected to the processing system.

12. The method in accordance with claim 6 comprising, in the processing system, the step of evaluating a ratio of incomplete tasks or sub-tasks to completed tasks or sub-tasks to assess compliance of the environmental management plan with the selected environmental management standard.

13. The method in accordance with claim 6 comprising, in the processing system, the step of generating forms and documents in response to player answers to instructions posed in a previous step.

14. The method in accordance with claim 6 comprising, in the processing system, the step of displaying a progress indicator on the display device, the progress indicator being an animation of a golf player playing the stroke associated with the relevant sub-task being undertaken on one of the holes.

15. An apparatus for preparing an environmental management plan for implementation in the environmental management of a golf course, the apparatus comprising a processing system for:
(i) displaying a plurality of holes and associated strokes either simultaneously or in a selected sequence, for playing a game of golf;
(ii) associating each critical task with a selected hole in the golf game;
(iii) associating a selected number of sub-tasks which are required to complete a respective critical task, with a stroke of a respective hole;
(iv) causing content and instructions associated with each sub-task to be displayed when the stroke is selected to be played.

16. A game for preparing an environmental management policy or plan to manage a golf course which complies with a selected environmental management standard, the game comprising: a playing area in the form of a metaphorical golf course; a plurality of rules which govern progression through the metaphorical golf course by completing each hole, the plurality of rules requiring progression through the metaphorical golf course be contingent upon completion of a number of tasks and sub-tasks in the environmental management policy, each task associated with a respective hole on the metaphorical golf course.

17. The game in accordance with claim 16 comprising a processing system which enables and controls play of the game and, during play of a hole of the game, presents players with a playing area and content for completing a task.

18. The game in accordance with claim 17 wherein templates are provided so that the player during play may customise the environmental management plan to the golf course which they are managing.

19. The game in accordance with claim 16 comprising an electronically linked environmental scorecard so that a player may be aware of how many holes have been completed.

20. The game in accordance with claim 19 wherein the scorecard is stored in the processing system so that the player may partially complete the game in one session and then save their progression at the partially completed stage and return to the game at a later date.

21. The game in accordance with claim 16 comprising an animated progress indicator that is in the form of an animated golfer who executes each metaphorical stroke associated with the sub-task and progresses along the hole as each sub-task is completed.

22. A computer program product including an environmental management program, wherein the computer product configures a computer to provide a computer generated graphical representation of holes of a golf course;
wherein each hole is assigned a number of environmental tasks, each environmental task being represented by a golf shot which must be completed to finish the hole; and
wherein each shot is recorded by the computer in an electronic scorecard and evaluated to determine the number of completed shots relative to a number of required shots to provide an indication of environmental performance.

23. A computer program product for interactively generating an environmental management plan for a golf course, the plan having a series of tasks required for completion of the plan, each task having at least one sub-task, wherein the computer program product configures a computer to:
(a) display the series of tasks, each task being associated with a hole of a metaphorical golf course;
(b) allow a user to select at least one of the holes of the metaphorical golf course;
(c) display a fairway of the selected hole of the metaphorical golf course, the fairway having a select number of shots, each shot being associated with a sub-task that is required to complete the hole;
(d) allowing a user to select at least one of the shots;
(e) displaying a location of the fairway associated with the shot;
(f) provide a link to a document that forms part of the environmental management plan, the document being required to be completed in order to complete the associated shot.

24. The computer program product of claim 23, wherein displaying the location on the fairway associated with the shot includes displaying an animated golf player.

25. The computer program product of claim 24, wherein on completing of a previous shot, the computer program product configures a computer to allow a user to select another shot which displays another location advanced along the fairway, the animated golf player being advanced along the fairway to the other location.

26. The computer program product of claim 23, wherein on completing of a previous shot, the computer program product configures a computer to allow a user to select another shot and display another location advanced along the fairway.

27. The computer program product of claim 23, wherein the computer program product configures a computer to display a scorecard which includes a list that associates each hole with the task.

28. The computer program product of claim 27, wherein the list further includes the number of shots required to complete each hole.

29. The computer program product of claim 27, wherein the scorecard further includes an indicator which displays a state of the hole to indicate if a particular hole has been completed.

30. The computer program product of claim 29, wherein the computer program product configures the computer to store in a memory device the state of the indicator.

31. The computer program product of claim 27, wherein the computer program product configures the computer to display the series of tasks, each task being associated with a hole of a metaphorical golf course whilst simultaneously displaying the scorecard.
